(19) United States
(12) Patent Application Publication
(10) Pub. No.: US 2023/0402624 A1
(43) Pub. Date: Dec. 14, 2023

(54) POWER GENERATION UNIT CELL AND FUEL CELL

(71) Applicant: TOYOTA JIDOSHA KABUSHIKI KAISHA, Toyota-shi (JP)

(72) Inventors: Kazunori SHIBATA, Mishima-shi (JP); Hitoshi HAMADA, Gotemba-shi (JP); Kotaro IKEDA, Mishima-shi (JP)

(73) Assignee: TOYOTA JIDOSHA KABUSHIKI KAISHA, Toyota-shi (JP)

(21) Appl. No.: 18/314,518

(22) Filed: May 9, 2023

(30) Foreign Application Priority Data
Jun. 14, 2022 (JP) 2022-095566

(51) Int. Cl. H01M 8/0276; H01M 8/1004

(52) U.S. Cl. CPC H01M 8/0276; H01M 8/1004; H01M 2008/1095

(57) ABSTRACT

A power generation unit cell includes: a membrane electrode assembly including an electrolyte membrane and catalyst layers located so as to sandwich the electrolyte membrane; a support located so as to surround the membrane electrode assembly; and a pair of separators located so as to sandwich the membrane electrode assembly and the support. The support includes a base material and adhesive layers stacked on both surfaces of the base material. Each of the separators includes a sealing part and a restraining part, in a portion of the separator that is bonded to corresponding one of the adhesive layers of the support. The sealing part is a smooth surface, and the restraining part is a portion with irregularities.

### CROSS-REFERENCE TO RELATED APPLICATION

This application claims priority to Japanese Patent Application No. 2022-095566 filed on Jun. 14, 2022, incorporated herein by reference in its entirety.

### BACKGROUND

### 1. Technical Field

The present disclosure relates to a power generation unit cell and a fuel cell.

### 2. Description of Related Art

Japanese Unexamined Patent Application Publication No. 2016-95902 (JP 2016-95902 A) discloses that protrusions in the form of a rib are provided on the adhesive side in order to provide a sufficient thickness of an adhesive layer. This configuration can provide a necessary thickness of the adhesive layer. Japanese Unexamined Patent Application Publication No. 2021-012838 (JP 2021-012838 A) discloses that a clamp load is applied to a stack of power generation cells of a fuel cell stack in the stacking direction of the power generation cells, first corrugated protrusions are formed outside a sealing bead portion integrally with a first metal separator, second corrugated protrusions are formed outside a sealing bead portion integrally with a second metal separator, and each of the first corrugated protrusions overlaps a corresponding one of the second corrugated protrusions such that the corrugated pattern of the first corrugated protrusions and the corrugated pattern of the second corrugated protrusions are out of phase with each other seen from the stacking direction.

### SUMMARY

A resin frame (support) is provided in an outer peripheral portion etc. of a power generation unit cell, and has a function to seal the inside of the power generation unit cell. However, a dimensional change of the resin frame due to heat and movement of the resin frame due to an external force etc. such as pressure or impact would affect sealing performance, adhesion strength, and dimensional stability. In the disclosure described in JP 2016-95902 A, a sufficient adhesion thickness can be provided. However, when the number of ribs is increased, voids such as air bubbles tend to develop. Such voids may cause leakage, or leakage may start from the voids, resulting in reduction in sealing performance. Moreover, since the ribs are provided in a portion that requires airtightness by sealing, this configuration cannot provide both sealing performance (leak resistance) and dimensional stability. The disclosure described in JP 2021-012838 A is a means for reducing application of a moment to a welded portion by a metal spring seal, but cannot reduce a dimensional change of a frame (support) due to its thermal contraction, creeping, etc. That is, since the corrugated protrusions are corrugated beads that are provided in order to reduce a bending moment, they cannot be expected to reduce movement of the frame (support).

The present disclosure provides a power generation unit cell having a structure that can provide both sealing performance and dimensional stability. The present disclosure also provides a fuel cell using this power generation unit cell.

One aspect of the present application provides a power generation unit cell. This power generation unit cell includes: a membrane electrode assembly including an electrolyte membrane and catalyst layers located so as to sandwich the electrolyte membrane; a support located so as to surround the membrane electrode assembly; and a pair of separators located so as to sandwich the membrane electrode assembly and the support. The support includes a base material and adhesive layers stacked on both surfaces of the base material. Each of the separators includes a sealing part that is a smooth surface and a restraining part that is a portion with irregularities, in a portion of the separator that is bonded to corresponding one of the adhesive layers of the support.

In the power generation unit cell of the above aspect, the restraining part may be provided with ridges protruding from a surface of the restraining part, the surface being on a side of the support, and the ridges adjacent to each other may be arranged at intervals.

In the power generation unit cell of the above aspect, a height of the ridges may be 20 μm or more and 80 μm or less, and the interval between the ridges adjacent to each other may be 0.4 mm or more and 1.5 mm or less.

In the power generation unit cell of the above aspect, the restraining part may be provided with grooves recessed from a surface of the restraining part, the surface being on a side of the support.

In the power generation unit cell of the above aspect, the restraining part may be provided with cylindrical protrusions on a surface of the restraining part, the surface being on a side of the support.

In the power generation unit cell of the above aspect, the protrusions may be arranged in a staggered manner.

In the power generation unit cell of the above aspect, the separator may include a protruding portion between the sealing part and the restraining part.

In the power generation unit cell of the above aspect, the sealing part and the restraining part may be located adjacent to each other.

Another aspect of the present application provides a fuel cell composed of a stack of a plurality of the power generation unit cells of the above aspect.

According to the present disclosure, a portion having high sealing performance and a portion that improves dimensional stability are separately provided. Both high sealing performance and high dimensional stability can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a power generation unit cell;

FIG. 2 is a sectional view of a power generation portion, illustrating a layer configuration of the power generation portion;

FIG. 3 is a sectional view of an outer peripheral portion, illustrating a layer configuration of the outer peripheral portion;

FIG. 4 is an enlarged view of a part of FIG. 3;

FIG. 5 is a plan view of a support;

FIG. 6A illustrates an example of the form of a restraining part;

FIG. 6B illustrates another example of the form of the restraining part;

FIG. 6C illustrates still another example of the form of the restraining part;

FIG. 7A is a diagram illustrating the position of a sealing portion;

FIG. 7B is another diagram illustrating the position of the sealing portion;

FIG. 8 illustrates another embodiment; and

FIG. 9 illustrates a fuel cell.

### DETAILED DESCRIPTION OF EMBODIMENTS

1. Power Generation Unit Cell

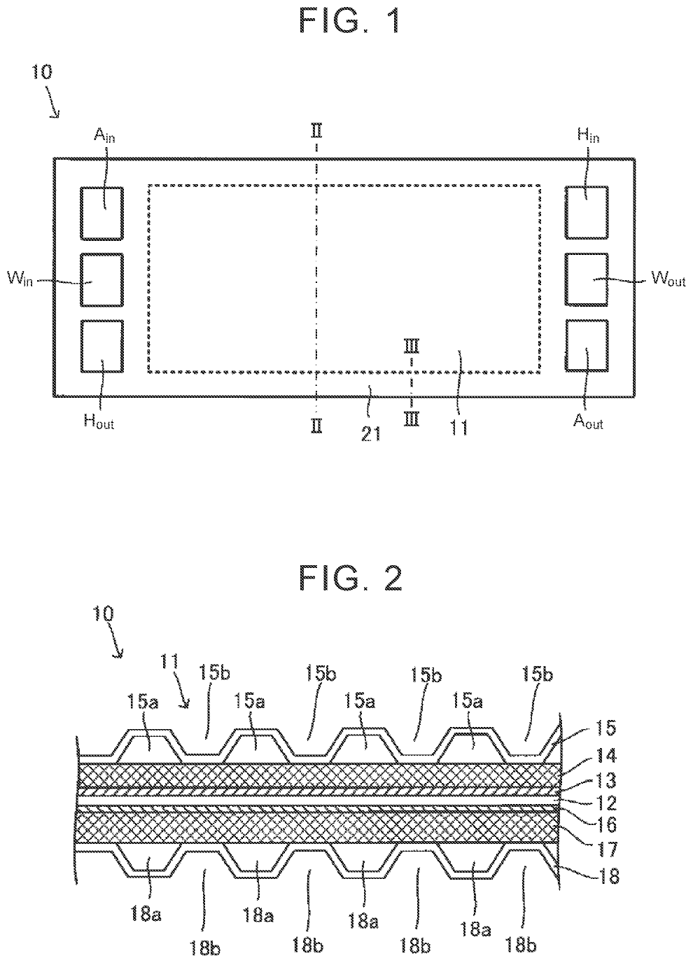

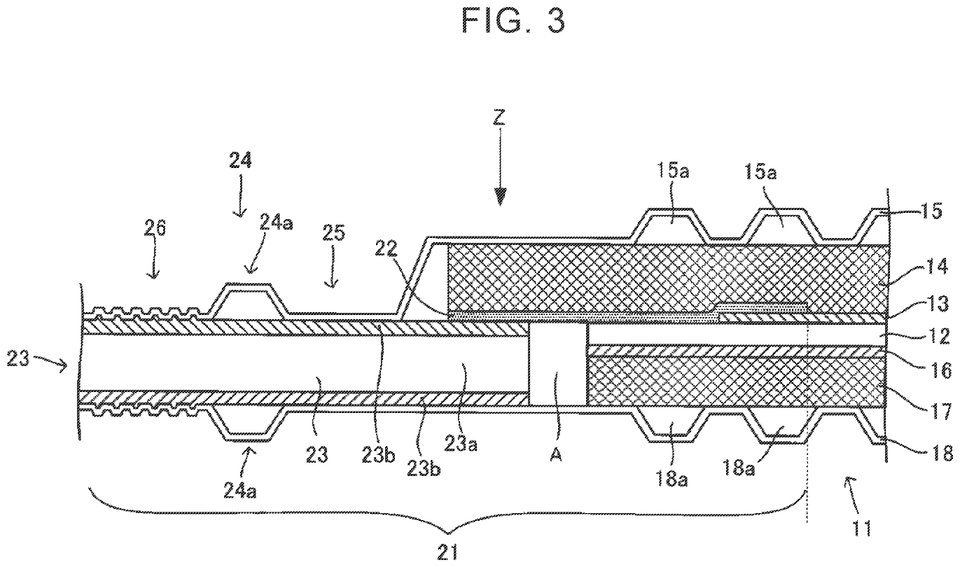

FIGS. 1 to 3 illustrate a power generation unit cell 10 according to an embodiment. The power generation unit cell 10 is a unit element for generating electricity when supplied with hydrogen and oxygen (air), and a plurality of such power generation unit cells 10 is stacked to form a fuel cell. FIG. 1 is a plan view of the power generation unit cell FIG. 2 illustrates a layer configuration in a power generation portion 11 of the power generation unit cell 10, and FIG. 3 illustrates a layer configuration in an outer peripheral portion 21 of the power generation unit cell 10.

1.1. Power Generation Portion

The power generation portion 11 is, for example, a portion that contributes to power generation as shown enclosed by a dashed line in FIG. 1. The power generation portion 11 is composed of a stack of a plurality of layers, as shown by the layer configuration in the power generation portion 11 in FIG. 2 (part of a section along line II-II in FIG. 1). In the power generation portion 11 of the power generation unit cell 10, a cathode (oxygen supply side) is disposed on one side across an electrolyte membrane 12 and an anode (hydrogen supply side) is disposed on the other side. The cathode includes a cathode catalyst layer 13, a cathode gas diffusion layer 14, and a cathode separator 15 that are stacked in this order from the electrolyte membrane 12 side. The anode includes an anode catalyst layer 16, an anode gas diffusion layer 17, and an anode separator 18 in this order from the electrolyte membrane 12 side. A stack of the electrolyte membrane 12, the cathode catalyst layer 13, and the anode catalyst layer 16 (stack of catalyst layers with an electrolyte membrane interposed therebetween) is sometimes called a membrane electrode assembly. A typical thickness of the membrane electrode assembly is around 0.4 mm, and a typical thickness of the power generation unit cell 10 in the power generation portion 11 is around 1.3 mm. For example, each layer is as follows.

1.1.1. Electrolyte Membrane

The electrolyte membrane 12 is a solid polymer electrolyte membrane that exhibits satisfactory proton conductivity in wet conditions. The electrolyte membrane 12 is, for example, a fluorine ion exchange membrane. For example, a carbon-fluorine polymer can be used as the electrolyte membrane 12. A specific example of the carbon-fluorine polymer is a perfluoroalkyl sulfonic acid polymer (Nafion (registered trademark)). The thickness of the electrolyte membrane 12 is, but is not particularly limited to, preferably 200 μm or less, more preferably 100 μm or less, even more preferably 50 μm or less.

1.1.2. Cathode Catalyst Layer

The cathode catalyst layer 13 is a layer containing a catalyst metal supported on a carrier. Examples of the catalyst metal include platinum (Pt), palladium (Pd), rhodium (Rh), and alloys containing these. Examples of the carrier include carbon carriers, more specifically, carbon particles of glassy carbon, carbon black, activated carbon, coke, natural graphite, and artificial graphite.

1.1.3. Anode Catalyst Layer

Like the cathode catalyst layer 13, the anode catalyst layer 16 is also a layer containing a catalyst metal supported on a carrier. Examples of the catalyst metal include Pt, Pd, Rh, and alloys containing these. Examples of the carrier include carbon carriers, more specifically, carbon particles of glassy carbon, carbon black, activated carbon, coke, natural graphite, and artificial graphite.

1.1.4. Cathode Gas Diffusion Layer

In the present embodiment, the cathode gas diffusion layer 14 is a layer of, for example, an electrically conductive porous material. More specific examples of the cathode gas diffusion layer 14 include carbon porous materials (such as carbon paper, carbon cloth, and glassy carbon) and metal porous materials (metal mesh and metal foam). The cathode gas diffusion layer 14 may be provided with a microporous layer (MPL), as needed. The MPL is a thin film in the form of a coating applied to the cathode catalyst layer 13 side of the cathode gas diffusion layer 14. The MPL is water repellent or hydrophilic, as needed, and has a function to adjust moisture. The MPL also serves to prevent fuzz etc. on a carbon porous material from sticking into the electrolyte membrane 12. Typically, the MPL mainly contains a water-repellent resin such as polytetrafluoroethylene (PTFE) and an electrically conductive material such as carbon black.

The thickness of the cathode gas diffusion layer 14 in the power generation portion 11 is preferably 50 μm or more and 250 μm or less. When the thickness of the cathode gas diffusion layer 14 in the power generation portion 11 is greater than 250 μm, the electrical resistance increases. When the thickness of the cathode gas diffusion layer 14 in the power generation portion 11 is less than 50 μm, the cathode gas diffusion layer 14 may not be flexible enough to obtain a uniform surface pressure in the power generation portion 11. More specifically, a surface pressure of 0.2 MPa or more and 2 MPa or less is applied to the power generation portion 11, and spring properties (elasticity) of the cathode gas diffusion layer 14 are used to keep the surface pressure in the power generation portion 11 constant.

1.1.5. Anode Gas Diffusion Layer

The anode gas diffusion layer 17 is a layer of, for example, an electrically conductive porous material. More specific examples of the anode gas diffusion layer 17 include carbon porous materials (such as carbon paper, carbon cloth, and glassy carbon) and metal porous materials (metal mesh and metal foam).

The thickness of the anode gas diffusion layer 17 in the power generation portion 11 is preferably 50 μm or more and 250 μm or less. When the thickness of the anode gas diffusion layer 17 in the power generation portion 11 is greater than 250 μm, the electrical resistance increases. When the thickness of the anode gas diffusion layer 17 in the power generation portion 11 is less than 50 μm, the anode gas diffusion layer 17 may not be flexible enough to obtain a uniform surface pressure in the power generation portion 11. More specifically, a surface pressure of 0.2 MPa or more and 2 MPa or less is applied to the power generation portion 11, and spring properties (elasticity) of the anode gas diffusion layer 17 are used to keep the surface pressure in the power generation portion 11 constant.

1.1.6. Cathode Separator

The cathode separator 15 is a member that supplies reactive gas (air in the present embodiment) to the cathode gas diffusion layer 14, and has a plurality of grooves 15a on its surface facing the cathode gas diffusion layer 14. The grooves 15a serve as reactive gas channels. The shape of the grooves 15a is not particularly limited as long as the reactive gas can be appropriately supplied to the cathode gas diffusion layer 14. For example, the grooves 15a are in the form of corrugations of a corrugated plate member as in the present embodiment. A typical thickness of the plate member is 0.1 mm or more and 0.2 mm or less, and a typical height of the corrugations of the plate member is around 0.5 mm. In this case, the cathode separator 15 has grooves 15b on the opposite side from the grooves 15a. Each groove 15b is formed between adjacent ones of the grooves 15a. The grooves 15b serve as coolant channels.

As can be seen from FIG. 1, the cathode separator 15 has an air inlet Aᵢₙ, a coolant inlet Wᵢₙ, and a hydrogen outlet Hₒᵤₜ at positions outside the power generation portion 11 in a portion extended from the power generation portion 11, namely in one end portion in the direction in which the grooves 15a, 15b extend. The cathode separator 15 further has an air outlet Aₒᵤₜ, a coolant outlet Wₒᵤₜ, and a hydrogen inlet Hᵢₙ at positions outside the power generation portion 11 in a portion extended from the power generation portion 11, namely in the other end portion in the direction in which the grooves 15a, 15b extend. The grooves 15a communicate with the air inlet Aᵢₙ and the air outlet Aₒᵤₜ, and the grooves 15b communicate with the coolant inlet Wᵢₙ and the coolant outlet Wₒᵤₜ.

The cathode separator 15 may be made of any material that can be used as a separator for a power generation unit cell, and may be made of a gas-impermeable, electrically conductive material. Examples of such a material include gas-impermeable dense carbon produced by compressing carbon, and press-formed metal plates.

1.1.7. Anode Separator

The anode separator 18 is a member that supplies reactive gas (hydrogen) to the anode gas diffusion layer 17, and has a plurality of grooves 18a on its surface facing the anode gas diffusion layer 17. The grooves 18a serve as reactive gas channels. The shape of the grooves 18a is not particularly limited as long as the reactive gas can be appropriately supplied to the anode gas diffusion layer 17. For example, the grooves 18a are in the form of corrugations of a corrugated plate member as in the present embodiment. A typical thickness of the plate member is 0.1 mm or more and 0.2 mm or less, and a typical height of the corrugations of the plate member is around 0.4 mm. In this case, the anode separator 18 has grooves 18b on the opposite side from the grooves 18a. Each groove 18b is formed between adjacent ones of the grooves 18a. The grooves 18b serve as coolant channels.

As can be seen from FIG. 1, the anode separator 18 has an air inlet Aᵢₙ, a coolant inlet Wᵢₙ, and a hydrogen outlet Hₒᵤₜ at positions outside the power generation portion 11 in a portion extended from the power generation portion 11, namely in one end portion in the direction in which the grooves 18a, 18b extend. The anode separator 18 further has an air outlet Aₒᵤₜ, a coolant outlet Wₒᵤₜ, and a hydrogen inlet Hᵢₙ at positions outside the power generation portion 11 in a portion extended from the power generation portion 11, namely in the other end portion in the direction in which the grooves 18a, 18b extend. The grooves 18a communicate with the hydrogen inlet Hᵢₙ and the hydrogen outlet Hₒᵤₜ, and the grooves 18b communicate with the coolant inlet Wᵢₙ and the coolant outlet Wₒᵤₜ.

The anode separator 18 may be made of any material that can be used as a separator for a power generation unit cell, and may be made of a gas-impermeable, electrically conductive material. Examples of such a material include gas-impermeable dense carbon produced by compressing carbon, and press-formed metal plates.

1.1.8. Power Generation by Power Generation Portion

As is known in the art, the power generation unit cell 10 described above generates electricity as follows. Hydrogen supplied from the hydrogen inlet Hᵢₙ, to the grooves 18a of the anode separator 18 passes through the anode gas diffusion layer 17 and is decomposed into protons (H⁺) and electrons (e⁻) in the anode catalyst layer 16. The protons reach the cathode catalyst layer 13 through the electrolyte membrane 12, and the electrons reach the cathode catalyst layer 13 through a conductive wire leading to the outside. The remaining hydrogen is discharged from the hydrogen outlet Hₒᵤₜ. Oxygen (air) is supplied from the air inlet Aᵢₙ to the cathode catalyst layer 13 through the grooves 15a of the cathode separator 15 and the cathode gas diffusion layer 14. Water (H₂O) is produced by the protons, electrons, and oxygen in the cathode catalyst layer 13. The produced water and the remaining air pass through the cathode gas diffusion layer 14, reach the grooves 15a of the cathode separator 15, and are discharged from the air outlet Aₒᵤₜ. In the power generation unit cell 10, the flow of the electrons through the conductive wire extending from the anode catalyst layer 16 to the outside is used as a current.

When forming a fuel cell, a plurality of power generation unit cells 10 is stacked such that the cathode separator 15 of one of adjacent ones of the power generation unit cells 10 is located under the anode separator 18 of the other power generation unit cell 10. The grooves 15b of the cathode separator 15 and the grooves 18b of the anode separator 18 thus form coolant channels. A coolant is supplied from the coolant inlet Wᵢₙ to the coolant channels. The supplied coolant cools the power generation unit cell 10 and is discharged from the coolant outlet Wₒᵤₜ.

1.2. Outer Peripheral Portion

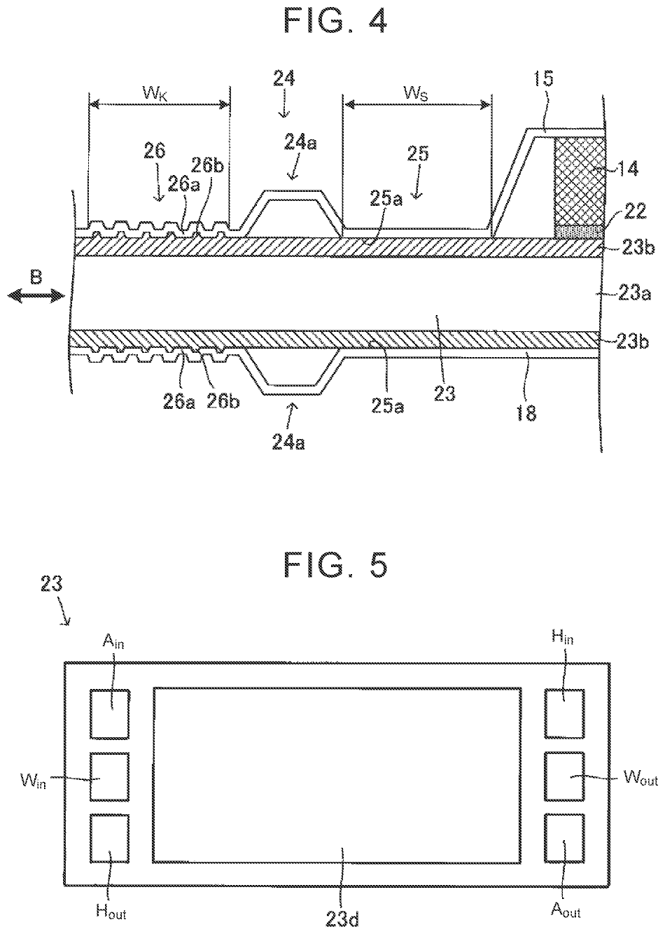

The outer peripheral portion 21 is a portion outside the power generation portion 11 shown enclosed by the dashed line in FIG. 1, and is an outer peripheral portion of the power generation unit cell 10. The outer peripheral portion 21 is composed of a stack of a plurality of layers, as shown by the layer configuration in the outer peripheral portion 21 in FIG. 3 (part of a section along line in FIG. 1). FIG. 4 is an enlarged view of a part of FIG. 3.

1.2.1. Basic Structure of Outer Peripheral Portion

As can be seen from FIGS. 3 and 4, in the present embodiment, at least a part of the outer peripheral portion 21 has the following configuration. The electrolyte membrane 12, the anode catalyst layer 16, and the anode gas diffusion layer 17 are stacked such that their end faces are approximately aligned. The cathode catalyst layer 13 is stacked such that its end face is located at a position inward of (withdrawn from) an end face of the electrolyte membrane 12. An end face of the cathode gas diffusion layer 14 is located at a position outward of (advanced from) the end face of the electrolyte membrane 12. The cathode gas diffusion layer 14 extends to such a position that the cathode gas diffusion layer 14 overlaps a support 23 as viewed in plan of the power generation unit cell 10 (from a viewpoint in the direction of FIG. 1, a line of sight in the direction shown by arrow Z in FIG. 3). The support 23 will be described later.

In the outer peripheral portion 21 as well, the cathode separator 15 and the anode separator 18 are disposed so as to sandwich the layers described above therebetween as in the power generation portion 11. In the outer peripheral portion 21, the outer peripheral portions of the cathode separator 15 and the anode separator 18 are extended so as to protrude beyond the end faces of the membrane electrode assembly, cathode gas diffusion layer 14, and anode gas diffusion layer 17. The support 23 is disposed between the extended portions of the outer peripheral portions of the cathode separator 15 and anode separator 18. The cathode separator 15 and the anode separator 18 require no flow channels in the outer peripheral portion 21. Therefore, the cathode separator 15 and the anode separator 18 have no grooves 15a, 18a in the outer peripheral portion 21 (however, as can be seen from FIG. 3, the present disclosure does not exclude a configuration in which the cathode separator 15 and the anode separator 18 have the grooves 15a, 18a in a part of the outer peripheral portion 21). That is, in the power generation unit cell 10, the stack including the membrane electrode assembly is sandwiched between a pair of separators (cathode separator 15 and anode separator 18) in the power generation portion 11, and the support 23 is sandwiched between the pair of separators in the outer peripheral portion 21.

A cover sheet 22 is disposed so as to connect an end portion of a cathode-side surface of the support 23 and an end portion of a cathode-side surface of the membrane electrode assembly. The cover sheet 22 will be described later.

1.2.2. Support

The support 23 functions as a member that seals between the cathode separator 15 and the anode separator 18 in the outer peripheral portion 21 of the power generation unit cell 10. FIG. 5 shows a plan view of the support 23 (from the same viewpoint as in FIG. 1). As can be seen from FIG. 5, the support 23 is a hollow frame member having an air inlet Aᵢₙ, a coolant inlet Wᵢₙ, a hydrogen outlet Hₒᵤₜ, an air outlet Aₒᵤₜ, a coolant outlet Wₒᵤₜ, a hydrogen inlet Hᵢₙ, and a hole in a portion 23d corresponding to the power generation portion 11.

The support 23 includes a base material 23a and adhesive layers 23b located on both surfaces (cathode-side surface and anode-side surface) of the base material 23a. The adhesive layers 23b are bonded to the cathode separator 15 and the anode separator 18 to seal the power generation portion 11 between the pair of separators. Bending is performed so that the interval between the cathode separator 15 and the anode separator 18 changes depending on the layer(s) sandwiched therebetween. As can be seen from FIGS. 3 and 4, this interval is reduced in a part of the portion where only the support 23 is located between the cathode separator 15 and the anode separator 18. In this part, the support 23 is sandwiched and fixed between the cathode separator 15 and the anode separator 18 (pair of separators), and this part serves as a sealing portion 24. The sealing portion 24 will be described later.

The base material 23a is made of any electrically insulating, airtight material. Examples of such a material include crystalline polymers, more specifically, engineering plastics. Examples of engineering plastics include polyethylene naphthalate (PEN) resins and polyethylene terephthalate (PET) resins, polyphenyl ether (PPE), polyphenylsulfone (PPSU), polysulfone (PSU), polyethersulfone (PES), polyether ether ketone (PEEK), polyimide (PI), polyetherimide (PEI), polyamide-imide (PAI), polyphenyl sulfide (PPS), syndiotactic polystyrene (SPS), and nylon resins. The thickness of the base material 23a is preferably, but not particularly limited to, 0.05 mm or more and 0.25 mm or less.

Known materials can be used for the adhesive layers 23b as long as they exhibit adhesive properties in a bonded state. Examples of the adhesive material used for the adhesive layers 23b include polyolefin polymers containing maleic acid or maleic anhydride. A more specific example of the adhesive material is ADMER (registered trademark, Mitsui Chemicals, Inc.). The thickness of the adhesive layers 23b is preferably, but not particularly limited to, 30 μm or more and 50 μm or less.

Such a frame-shaped support 23 is disposed so as to surround the stack in the power generation portion 11 including the membrane electrode assembly. As can be seen from FIG. 3, the support 23 is disposed such that an end face of the support 23 faces the end faces of the membrane electrode assembly and anode gas diffusion layer 17 with a space A therebetween. This space A can absorb dimensional changes of the support 23, the membrane electrode assembly, etc. due to their linear expansion, and can reduce the possibility of damage due to expansion and contraction. More specifically, the distance of the space A in the direction in which the support 23 faces the membrane electrode assembly and the anode gas diffusion layer 17 is preferably 0.01 mm or more and 2 mm or less. When the distance is less than 0.01 mm, it is difficult for the space A to absorb a dimensional change of the support 23. When the distance is larger than 2 mm, the differential pressure between the space A and the cathode gas diffusion layer 14 may cause deformation of or damage to the support 23, resulting in reduction in sealing performance.

1.2.3. Cover Sheet

As described above, the cover sheet 22 is disposed so as to connect the end portion of the cathode-side surface of the support 23 and the end portion of the cathode-side surface of the membrane electrode assembly.

The cover sheet 22 is disposed such that one end portion of the cover sheet 22 covers the end portion of the cathode-side surface of the support 23 and the other end portion of the cover sheet 22 covers an end portion of a surface of either or both of the electrolyte membrane 12 and the cathode catalyst layer 13 of the membrane electrode assembly (in the present embodiment, the cover sheet 22 is disposed so as to cover the end portions of the surfaces of both the electrolyte membrane 12 and the cathode catalyst layer 13). The cathode and the anode can thus be appropriately separated in the outer peripheral portion 21. Accordingly, the cover sheet 22 is located between the membrane electrode assembly and the cathode gas diffusion layer 14 in the end portion of the membrane electrode assembly.

A material impermeable to the reactive gases of the fuel cell is used for the cover sheet 22. Examples of a member impermeable to the reactive gases include film members made of resin such as polypropylene, polyphenylene sulfide, polyethylene naphthalate, nylon, or ethylene vinyl alcohol copolymer. Particularly, Nylon 11, Nylon 12, Nylon 9T, or ethylene vinyl alcohol can be used from the standpoint of hydrolysis resistance and adhesion to the electrolyte membrane 12. For example, an additive having an amide group, an epoxy group, a hydroxyl group, etc. may be added in order to improve adhesion to the electrolyte membrane 12.

An overlapping portion of the cover sheet 22 with the support 23 is bonded to the support 23 by the adhesive layer 23b of the support 23. An overlapping portion of the cover sheet 22 with the membrane electrode assembly is bonded to the membrane electrode assembly by an adhesive layer that is provided on the cover sheet 22 as necessary. However, when nylon is used as the cover sheet 22, the adhesive layer may be omitted as the cover sheet 22 and the membrane electrode assembly can be bonded together by thermocompression bonding.

1.2.4. Sealing Portion

In the sealing portion 24, only the support 23 is located between the cathode separator 15 and the anode separator 18, and the support 23 is sandwiched and fixed between the cathode separator 15 and the anode separator 18 for sealing. The sealing portion 24 is configured to perform sealing by the forms of the cathode separator 15, anode separator 18, and support 23. This will be described in detail below.

As can be seen from FIGS. 3 and 4, in the present embodiment, the sealing portion 24 includes a sealing part 25 and a restraining part 26. In the present embodiment, each of the cathode separator 15 and the anode separator 18 has a protruding portion 24a between the sealing part 25 and the restraining part 26.

Sealing Part

The sealing part 25 is a portion where surfaces 25a of the cathode separator and anode separator 18 that contact the adhesive layers 23b of the support 23 are smooth. This portion provides high sealing performance by contact between the smooth surfaces 25a and the adhesive layers 23b. If the contact surfaces with the adhesive layers 23b have irregularities, air bubbles may develop on the surfaces of the adhesive layers 23b, resulting in reduction in sealing performance. The sealing part 25 can provide high sealing performance because the smooth surfaces 25a can be bonded to the adhesive layers 23b.

The degree of smoothness of the smooth surfaces 25a in the sealing part 25 is not particularly limited as long as sufficient sealing performance can be provided. However, for example, the maximum height Rz of the smooth surfaces 25a in the sealing part 25 as defined in JIS B 0601-2001 (ISO 4287-1997) is preferably 0.5 μm or less. The width W_{S} of the sealing part 25 shown in FIG. 4 is preferably 1 mm or more and 5 mm or less.

Restraining Part

The restraining part 26 is a portion where at least surfaces of the cathode separator 15 and anode separator 18 that contact the adhesive layers 23b of the support 23 have irregularities (protruding portions 26a, recessed portions 26b). This portion restricts movement of the support 23 as the adhesive layer 23b enters the recessed portions 26b and the adhesive layer 23b bites into the protruding portions 26a. The support 23 can be restrained by the restraining part 26, so that movement of the support 23 in the direction shown by straight arrow B in FIG. 4, such as thermal expansion and contraction of the support 23 or a dimensional change of the support 23 due to a collision etc., can be reduced and dimensional stability can be improved. Since the contact area is increased by the irregularities, adhesion (adhesive strength) between each of the cathode separator 15 and the anode separator 18 and the support 23 can be increased.

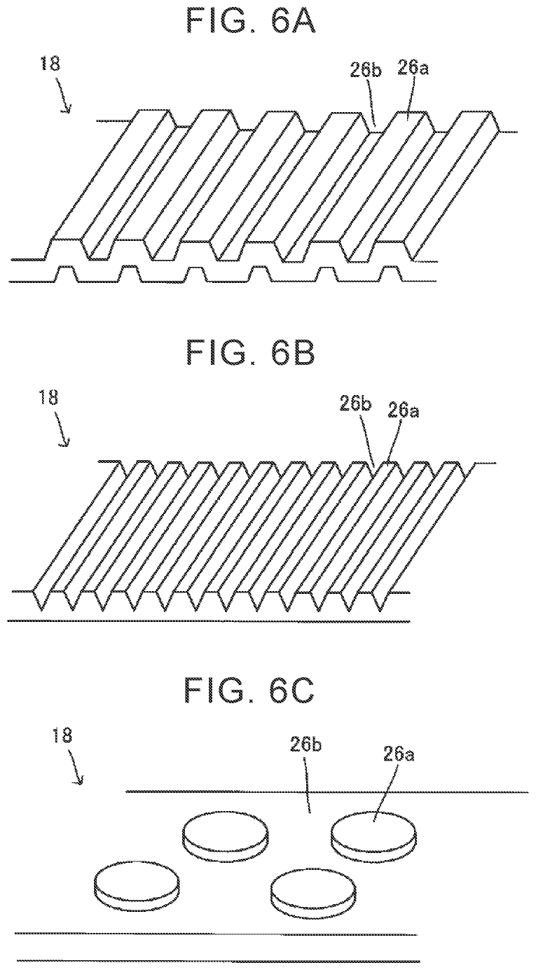

The form of the irregularities of the restraining part 26 is not particularly limited as long as the irregularities have a structure capable of restricting the movement of the support 23 more than the sealing part 25 does. For example, the irregularities of the restraining part 26 can be in such forms as shown in FIGS. 6A to 6C. FIGS. 6A to 6C schematically show a part of the surface of the anode separator 18 that has the protruding portions 26a and the recessed portions 26b in the restraining part 26. The same applies to the cathode separator 15.

In the example of FIG. 6A, the anode separator 18 is corrugated in the restraining part 26, and has ridges and furrows on its front and back surfaces. Of the ridges and furrows, the ridges and furrows formed on the support 23 side serve as the protruding portions 26a (ridges) and the recessed portions 26b (furrows), respectively. In the present embodiment, the direction in which the protruding portions 26a extend and the direction in which the recessed portions 26b extend are approximately parallel, and the protruding portions 26a and the recessed portions 26b are alternately arranged in a direction perpendicular to the directions in which the protruding portions 26a and the recessed portions 26b extend. It is preferable that the protruding portions 26a and the recessed portions 26b be alternately arranged in a direction toward the closest outer peripheral end of the power generation unit cell 10, although the present disclosure is not particularly limited to this. The movement of the support 23 can thus be more effectively reduced.

Although the sizes of the protruding portions 26a and recessed portions 26b are not particularly limited, the height of the protruding portions 26a and the depth of the recessed portions 26b can be 20 μm or more and 80 μm or less, and the repetition intervals, namely the pitch, of adjacent protruding portions 26a (or adjacent recessed portions 26b) can be 0.4 mm or more and 1.5 mm or less. The width W_{K} of the restraining part 26 shown in FIG. 4 is preferably 1 mm or more and 5 mm or less.

In the example of FIG. 6B, the anode separator 18 has grooves arranged at intervals on its surface facing the support 23 in the restraining part 26. These grooves serve as the recessed portions 26b, and the portions between the recessed portions 26b serve as the protruding portions 26a. In this example as well, the protruding portions 26a are ridges and the recessed portions 26b are grooves. Therefore, this example can be considered similarly to the example in FIG. 6A. The grooves serving as the recessed portions 26b may be fine grooves. In that case, the grooves can be formed by laser engraving.

In the example of FIG. 6C, the anode separator 18 has protrusions arranged on its surface facing the support 23 in the restraining part 26. These protrusions serve as the protruding portions 26a, and the portions between the protruding portions 26a serve as the recessed portions 26b. In this form, the protruding portions 26a are cylindrical protrusions. However, the present disclosure is not limited to this. The protruding portions 26a may be in other shapes such as prisms (e.g., quadrangular prism or triangular prism) or pyramids (e.g., cone, triangular pyramid, or quadrangular pyramid). Alternatively, the protruding portions 26a may be in the form of corrugations, embossed protrusions, or dimples. Although the arrangement of the protrusions is not particularly limited, the protrusions may be arranged in a matrix, or may be arranged in a staggered manner (so-called staggered array). Although the sizes of the protruding portions 26a and recessed portions 26b are not particularly limited, the height of the protruding portions 26a and the depth of the recessed portions 26b can be μm or more and 80 μm or less, and the repetition intervals, namely the pitch, of adjacent protruding portions 26a (or adjacent recessed portions 26b) can be 0.4 mm or more and 1.5 mm or less. The width W_{K} of the restraining part 26 shown in FIG. 4 is preferably 1 mm or more and 5 mm or less.

In addition to the above, although not shown in the figures, the form of the irregularities in the restraining part 26 may be provided by a rough surface. In this case, irregularities due to surface roughness form the protruding portions 26a and the recessed portions 26b. Although the degree of surface roughness is not particularly limited, the rough surface is at least rougher than the smooth surface 25a in the sealing part 25. Specifically, for example, the maximum height Rz of the rough surface as defined in JIS B 0601-2001 (ISO 4287-1997) is preferably 20 μm or more and 50 μm or less. Such irregularities can be formed by press forming, shot blasting, laser irradiation, etc.

Position of Sealing Portion

In the present embodiment, the sealing part 25 is located on the inner side of the sealing portion 24 (side closer to the power generation portion 11), and the restraining part 26 is located on the outer side of the sealing portion 24 (side closer to the outer periphery). However, the present disclosure is not limited to this, and the positions of the sealing part 25 and the restraining part 26 may be opposite to those described above.

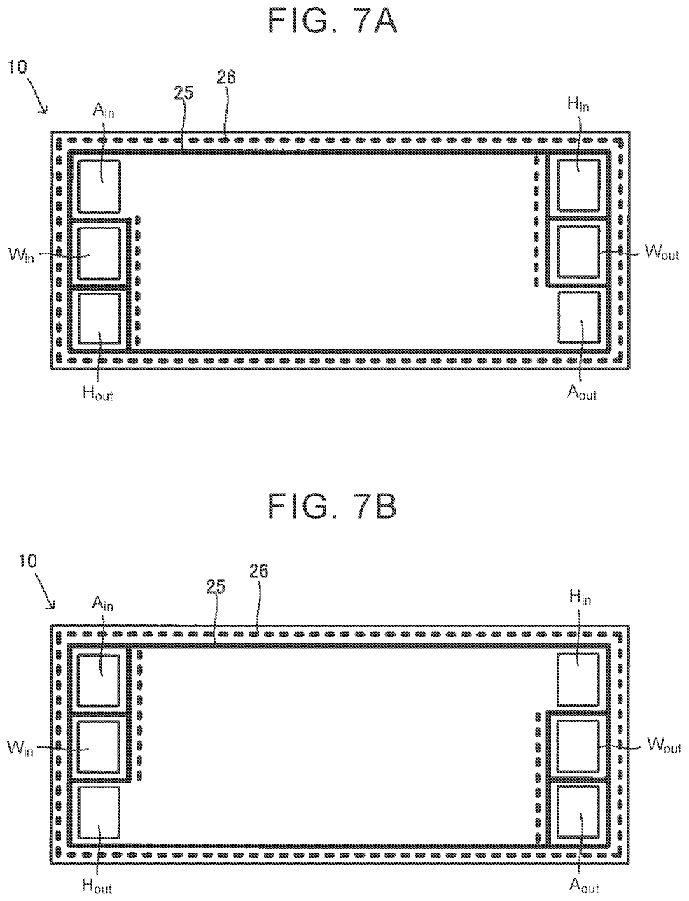

FIGS. 7A and 7B show the position of the sealing portion 24 in the power generation unit cell 10. FIG. 7A shows the cathode (oxygen supply side), and FIG. 7B shows the anode (hydrogen supply side). In each figure, the sealing part 25 is shown by thick continuous lines, and the restraining part 26 is shown by dashed lines. As described above, the sealing portion 24 is disposed in the outer peripheral portion of the power generation unit cell 10 and around the fluid inlets and outlets as necessary. In the present disclosure, the sealing part 25 and the restraining part 26 are separately provided and are disposed side by side at different positions in the sealing portion 24.

Others

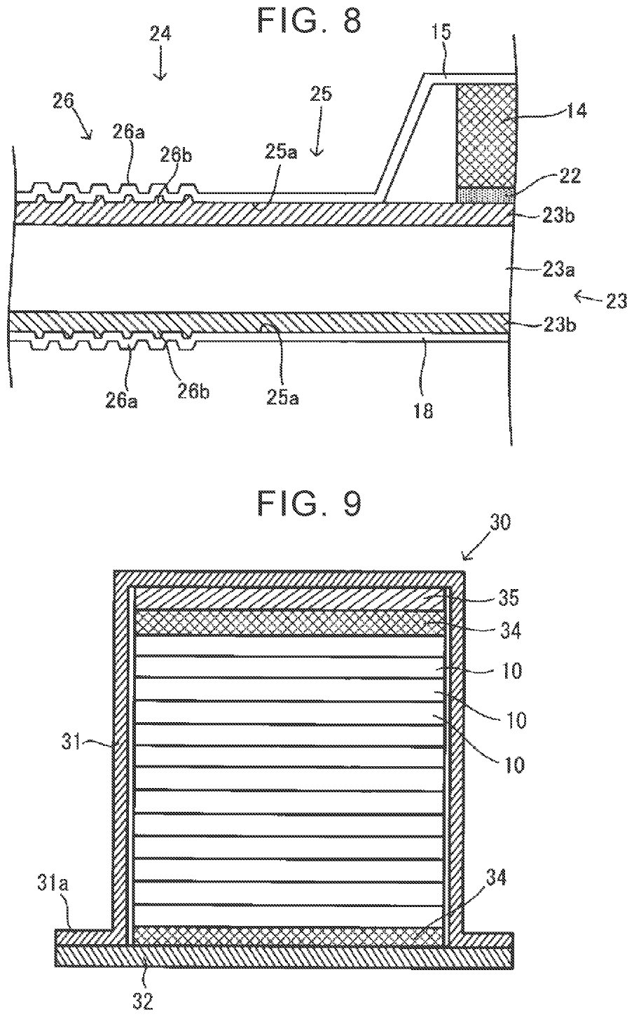

In the embodiment shown in FIG. 4, each of the cathode separator 15 and the anode separator 18 has the protruding portion 24a between the sealing part 25 and the restraining part 26. As will be described later, when stacking a plurality of power generation unit cells 10 to form a fuel cell 30, an adhesive sheet for bonding adjacent ones of the power generation unit cells 10 together is placed so as to bond the protruding portions 24a of the adjacent power generation unit cells 10 together, thereby fixing the adjacent power generation unit cells 10 together. The protruding portion 24a need not necessarily be located between the sealing part 25 and the restraining part 26. The sealing part 25 and the restraining part 26 may be located next to each other as shown in FIG. 8. In this case, the protruding portion 24a can be provided at a different position.

2. Fuel Cell

The fuel cell 30 is a member formed by stacking a plurality of (around 50 to 400) power generation unit cells 10 described above. The fuel cell 30 collects a current from the power generation unit cells 10. FIG. 9 shows an overview of the configuration of the fuel cell 30. The fuel cell 30 includes a stack case 31, an end plate 32, a plurality of power generation unit cells 10, a current collector plate 34, and a biasing member 35.

The stack case 31 is a housing that houses a stack of the power generation unit cells 10, the current collector plate 34, and the biasing member 35 therein. In the present embodiment, the stack case 31 is in the shape of a rectangular prism that is open at one end and closed at the other end, with a plate-like piece extending along the edge of the opening and protruding toward the opposite side from the opening to form a flange 31a.

The end plate 32 is a plate member that closes the opening of stack case 31. An overlapping portion of the end plate 32 with the flange 31a of the stack case 31 is fixed to the flange 31a by bolts and nuts etc. so that the end plate 32 closes the stack case 31.

The power generation unit cell 10 is as described above. A plurality of such power generation unit cells 10 is stacked on top of each other. The power generation unit cells 10 are stacked such that the cathode separator 15 of one power generation unit cell 10 is located under the anode separator 18 of the power generation unit cell 10 adjacent to the one power generation unit cell 10. The grooves 15b of the cathode separator 15 and the grooves 18b of the anode separator 18 thus face each other to form coolant channels. An adhesive (bonding) sheet is placed between adjacent ones of the power generation unit cells 10. With the protruding portions 24a (see FIGS. 3 and 4) of the adjacent power generation unit cells 10 being bonded together by the adhesive sheet, the adjacent power generation unit cells 10 are stably fixed together.

The current collector plate 34 is a member that collects a current from the stack of the power generation unit cells 10. Accordingly, the current collector plate 34 is placed at one end and the other end of the stack of the power generation unit cells 10. One of the current collector plates 34 serves as a positive electrode, and the other current collector plate 34 serves as a negative electrode. Terminals, not shown, are connected to the current collector plates 34, so that the current collector plates 34 can be electrically connected to the outside.

The biasing member 35 fits inside the stack case 31, and applies a pressing force to the stack of the power generation unit cells 10 in the stacking direction thereof. An example of the biasing member is a disc spring.

3. Effects Etc.

In the present disclosure, the sealing part having high sealing performance and high airtightness and the restraining part that reduces movement of the support caused by heat, differential pressure, impact, etc. are separately provided in the sealing portion of the power generation unit cell. Therefore, both sealing performance and dimensional stability can be reliably provided without interfering with each other. For example, if an attempt is made to ensure sealing performance without separately providing the sealing part and the restraining part, movement of the support cannot be sufficiently restrained, and problems may arise with shape stability and sealing performance. On the other hand, if sealing is performed only by the irregular surfaces in order to restrain movement of the support, air bubbles may develop on the protruding and recessed portions, which may reduce the sealing performance. According to the present disclosure, as described above, both the sealing performance and the dimensional stability can be reliably provided without interfering with each other.

What is claimed is:

1. A power generation unit cell comprising:
a membrane electrode assembly including an electrolyte membrane and catalyst layers located so as to sandwich the electrolyte membrane;
a support located so as to surround the membrane electrode assembly; and
a pair of separators located so as to sandwich the membrane electrode assembly and the support, wherein
the support includes a base material and adhesive layers stacked on both surfaces of the base material, and
each of the separators includes a sealing part that is a smooth surface and a restraining part that is a portion with irregularities, in a portion of the separator that is bonded to corresponding one of the adhesive layers of the support.

2. The power generation unit cell according to claim 1, wherein the restraining part is provided with ridges protruding from a surface of the restraining part, the surface being on a side of the support, and
the ridges adjacent to each other are arranged at intervals.

3. The power generation unit cell according to claim 2, wherein a height of the ridges is 20 μm or more and 80 μm or less, and the interval between the ridges adjacent to each other is 0.4 mm or more and 1.5 mm or less.

4. The power generation unit cell according to claim 1, wherein the restraining part is provided with grooves recessed from a surface of the restraining part, the surface being on a side of the support.

5. The power generation unit cell according to claim 1, wherein the restraining part is provided with cylindrical protrusions on a surface of the restraining part, the surface being on a side of the support.

6. The power generation unit cell according to claim 5, wherein the protrusions are arranged in a staggered manner.

7. The power generation unit cell according to claim 1, wherein the separator includes a protruding portion between the sealing part and the restraining part.

8. The power generation unit cell according to claim 1, wherein the sealing part and the restraining part are located adjacent to each other.

9. A fuel cell comprising a plurality of the power generation unit cells according to claim 1 that are stacked.
